(19) United States
(12) Patent Application Publication
(10) Pub. No.: US 2023/0329143 A1
(43) Pub. Date: Oct. 19, 2023

(54) VEHICLE CONTROL MODULE FOR AUTONOMOUS VEHICLE

(71) Applicant: Ariens Company, Brillion, WI (US)

(72) Inventors: Craig Siebert, Neenah, WI (US); Kristopher M. Kommes, De Pere, WI (US); Michael J. Holeton, Kaukauna, WI (US)

(21) Appl. No.: 18/041,040

(22) PCT Filed: Aug. 13, 2021
(86) PCT No.: PCT/US2021/045904

§ 371 Date: Feb. 8, 2023

Related U.S. Application Data
(60) Provisional application No. 63/066,066, filed on Aug. 14, 2020.

(51) Int. Cl. A01D 34/00; B60W 50/08; B60W 50/02

(52) U.S. Cl. CPC A01D 34/008; B60W 50/082; B60W 50/0205; A01D 2101/00

(57) ABSTRACT

A vehicle control module for an autonomous vehicle. In one example embodiment, the control module is configured to receive, from a user interface, a user input selecting an operation mode. The module is configured to, responsive to receiving the user input, retrieve, from a memory, a discrete operational parameter set associated with the operation mode. The module is configured to apply the discrete operational parameter set. The module is configured to operate a drive motor of the utility vehicle, a drive wheel of the utility vehicle, a utility device of the utility vehicle, a power source of the utility vehicle, and the user interface according to the discrete operational parameter set.

### CROSS-REFERENCE TO RELATED APPLICATIONS

The present application is related to and claims benefit under 35 U.S.C. § 119(e) from U.S. Provisional Patent Application Ser. No. 63/066,066, filed Aug. 14, 2020, entitled “VEHICLE CONTROL MODULE FOR AUTONOMOUS VEHICLE,” the entire contents of which being incorporated herein by reference.

### FIELD OF THE INVENTION

The present invention relates to a vehicle control module for an autonomous vehicle. The autonomous vehicle may be an electric zero turn mower, a snow thrower, or the like.

### BRIEF DESCRIPTION OF THE DRAWINGS

FIG. 1 is a perspective view of an electric zero turn lawn mower according to the present invention, according to some embodiments.

FIG. 2 is another perspective view of the lawn mower of FIG. 1, according to some embodiments.

FIG. 3 is a bottom perspective view of the lawn mower, according to some embodiments.

FIG. 4 is a perspective view of a battery compartment of the mower of FIG. 1, according to some embodiments.

FIG. 5 is a block diagram of the sensors of the mower of FIG. 1, according to some embodiments.

FIG. 6 is a block diagram illustrating logic of a mode selection feature of the mower, according to some embodiments.

FIG. 7 is a graph illustrating aspects of the operation of the lawn more of FIG. 1, according to some embodiments.

FIG. 8 is a graph illustrating aspects of the operation of the lawn more of FIG. 1, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. As used herein, terms relating to position (e.g., front, rear, left, right, etc.) are relative to an operator situated on a utility vehicle during normal operation of the utility vehicle.

Also, it is to be understood that the phraseology and terminology used herein is for the purpose of description and should not be regarded as limiting. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc. It should also be noted that a plurality of hardware and software-based devices, as well as a plurality of different structural components may be utilized to implement aspects of the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more processors, one or more memory modules including non-transitory computer-readable medium, one or more input/output interfaces, and various connections (for example, a system bus) connecting the components.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

One problem addressed with the present invention arises from the nature of a vehicle control module that includes security features and control parameters to provide smooth operation for an operator. To allow the mower to operate in an autonomous mode, the vehicle control module disclosed herein modifies specific security features and control parameters.

One example embodiment includes a utility vehicle. The utility vehicle includes a frame, a drive wheel supporting the frame above a ground surface, a drive motor mounted to the frame and driving rotation of the drive wheel to move the utility vehicle over the ground surface, a utility device coupled to the frame, a power source supported by the frame, a user interface, and a vehicle control module including a memory. The vehicle control module is in communication with the drive motor, the utility device, the power source, and the user interface. The vehicle control module is configured to receive, from the user interface, a user input selecting an operation mode. The vehicle control module is configured to responsive to receiving the user input, retrieve, from the memory, a discrete operational parameter set associated with the operation mode. The vehicle control module is configured to apply the discrete operational parameter set. The vehicle control module is configured to operate the drive motor, the drive wheel, the utility device, the power source, and the user interface according to the discrete operational parameter set.

Another example embodiment includes a method for operating a utility vehicle. The method includes receiving, by an electronic controller from a user interface, a user input selecting an operation mode. The method includes, responsive to receiving the user input, retrieving, from a memory coupled to the electronic controller, a discrete operational parameter set associated with the operation mode. The method includes applying the discrete operational parameter set. The method includes operating a drive motor of the utility vehicle, a drive wheel of the utility vehicle, a utility device of the utility vehicle, a power source of the utility vehicle, and the user interface according to the discrete operational parameter set.

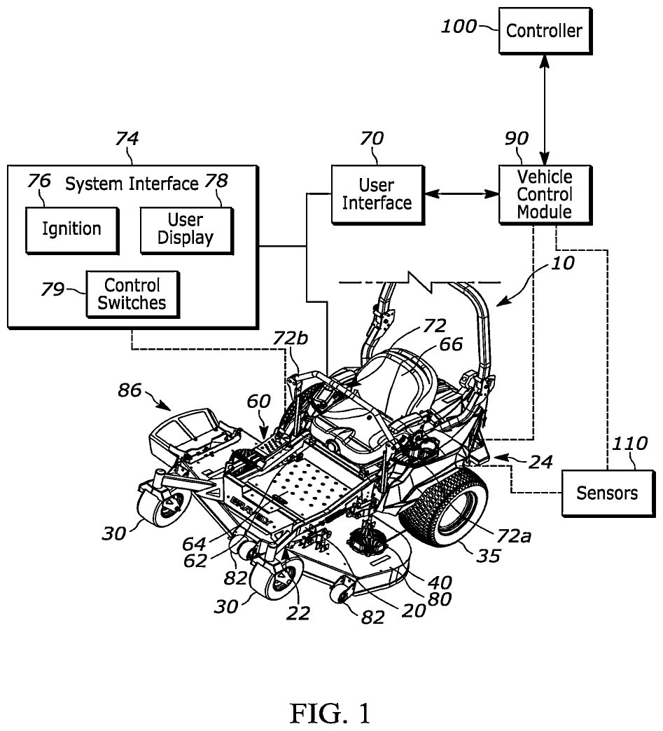

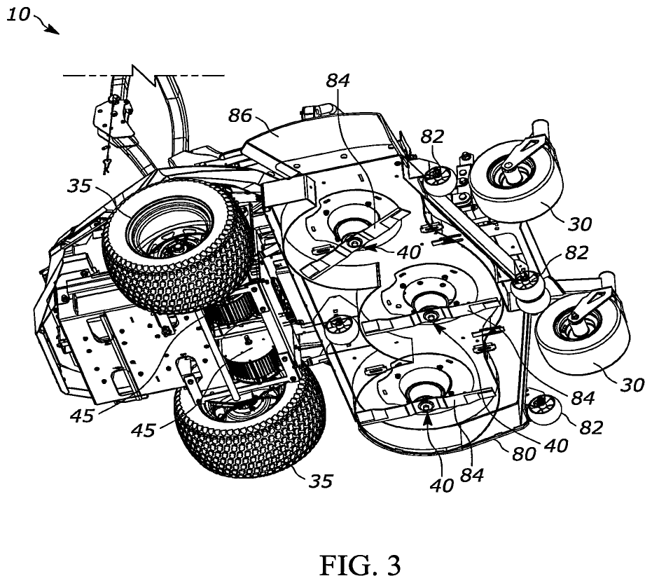

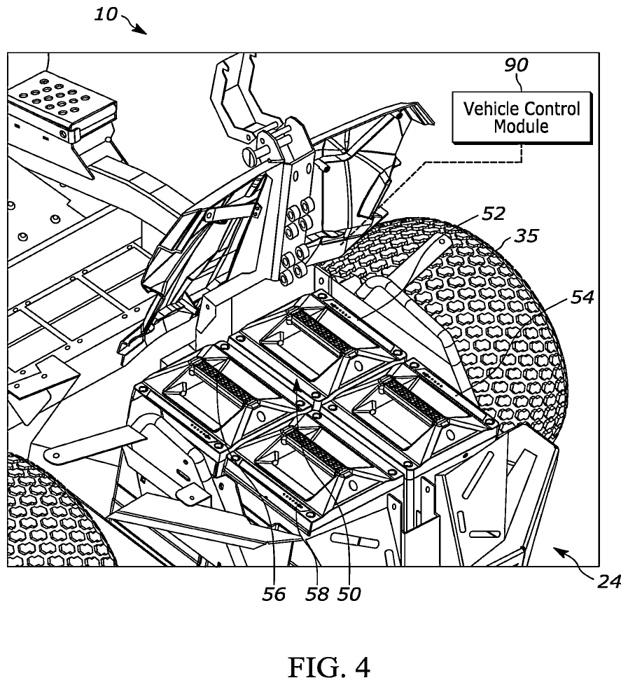

FIGS. 1-3 illustrate an example embodiment of a lawn mower 10. The lawn mower 10 may be, for example, an electric lawn mower, or a hybrid lawn mower. The illustrated lawn mower 10 includes a frame 20, ground engaging elements 30, 35, a prime mover 40, 45 (FIGS. 1 and 3), a power source 50 (FIG. 4), an operator platform 60, a user interface 70 (illustrated schematically in FIG. 1), a cutting deck 80, and a vehicle control module 90 (illustrated schematically in FIG. 1), a controller 100 in communication with the vehicle control module 90, and a plurality of sensors 110 in communication with the vehicle control module 90, described in more detail below. The controller 100 is, for example, a hand-held device, a smart telephone, a tablet computer, and the like. The controller 100 and the vehicle control module 90 of the lawn mower 10 may communicate over, for example, a Bluetooth network, a Wi-Fi network, or the like. For example, the controller 100 may be off board the mower 10 and interact with the mower 10 through an application on a mobile device. In some embodiments, the controller 100 may be on-board the mower 10. In some embodiments, the controller 100 may include a first controller on-board the mower 10 and a second controller off-board the mower 10, and the functionality of the controller 100 described herein may be implemented by the first controller, the second controller, or both controllers (redundantly or with functionality divided between the two controllers). While the vehicle control module 90 and the controller 100 are separately illustrated, it should be appreciated that the vehicle control module 90 and the controller 100 may be implemented by a single device (e.g., a single microcontroller with an electronic processor and memory).

The frame 20 includes a first or front portion 22 (extending to the center of the frame) and a second or rear portion 24 (meeting the front portion at the center of the frame) opposite the front portion 22. The frame 20 defines the basic body structure or chassis of the lawn mower 10 and supports the other components of the lawn mower 10. The frame 20 is supported by the ground engaging elements 30, 35 and in turn supports the other components of the lawn mower 10.

The ground-engaging elements 30, 35 are movably (e.g., rotatably) coupled to the frame 20. The illustrated ground-engaging elements 30, 35 include two first or front ground-engaging elements 30 coupled to the front portion 22 of the frame 20, and two second or rear ground-engaging elements 35 coupled to the rear portion 24 of the frame 20. In the illustrated embodiment, the ground-engaging elements 30, 35 are rotatable wheels but in other embodiments could be tracks for example. In the illustrated embodiment, the first (front) ground-engaging elements 30 are passive (i.e., rotating in response to movement of the lawn mower) caster wheels and the second (rear) ground-engaging elements 35 are the driven (i.e., rotating to cause movement of the lawn mower) wheels rotating under the influence of the drive motors 45. The second (rear) ground-engaging elements 35 may be referred to in the illustrated embodiment as the drive wheels or the left and right drive wheels 35, it being understood that the terms “left” and “right” are from the perspective of an operator in an ordinary operating position on the lawn mower. The drive wheels 35 are rotated by the drive motors 45 at a selected speed and direction to effect movement and steering of the lawn mower 10 in the well-known manner of a zero-turn radius lawn mower. In other embodiments, similar prime movers may also or alternatively be coupled to the two first ground-engaging elements 30 for the same purpose as the drive motors 45. In other embodiments, the lawn mower may take the form of a stand-on mower or a tractor-style mower with steerable wheels.

The prime movers 40, 45 may, for example, be an internal combustion engine, one or more electric motors, a hybrid gas/electric drive system, etc. With reference to FIGS. 1-3, the prime mover 40, 45 of the illustrated embodiment comprises a plurality of prime movers in the form of dedicated drive motors 45 (FIG. 3) and deck motors 40. The drive motors 45 are supported by the frame 20, with an output shaft of each directly coupled to one of the drive wheels 35 to independently drive rotation of the associated drive wheel 35 at a selected speed and direction. The drive wheels 35 may therefore be characterized as direct-drive wheels with dedicated drive motors 45. In alternative embodiments the drive motors 45 may be interconnected to the drive wheels 35 through a transmission or gear train to increase speed or torque delivered to the drive wheels 35. Speed and steering of the mower in the illustrated embodiment are effected by the direction and relative speeds of the drive wheels 35. To elaborate further on the point made earlier, the deck motors 40 and drive motors 45 together comprise what is referred to as the prime mover of the illustrated lawn mower 10. In the illustrated embodiment a deck motor 40 is dedicated to each blade and a drive motor 45 is dedicated to each drive wheel 35, but in other embodiments the work of some or all of these deck and drive motors 40, 45 can be combined in a single motor that distributes torque to multiple blades and/or drive wheels through power transmissions.

Turning now to FIG. 4, the power source 50 in the illustrated embodiment is a bank (plurality) of battery packs 52, 54, 56, 58. The power source 50 is electrically coupled to the drive motors 45 and deck motors 40 to provide sufficient power for their operation. The power source 50 is illustrated as being supported in the rear portion 24 of the frame 20, but in other embodiments may be supported on the front portion 22 or in the center of the frame 20 (e.g., straddling the front and rear portions 22, 24 of the frame 20).

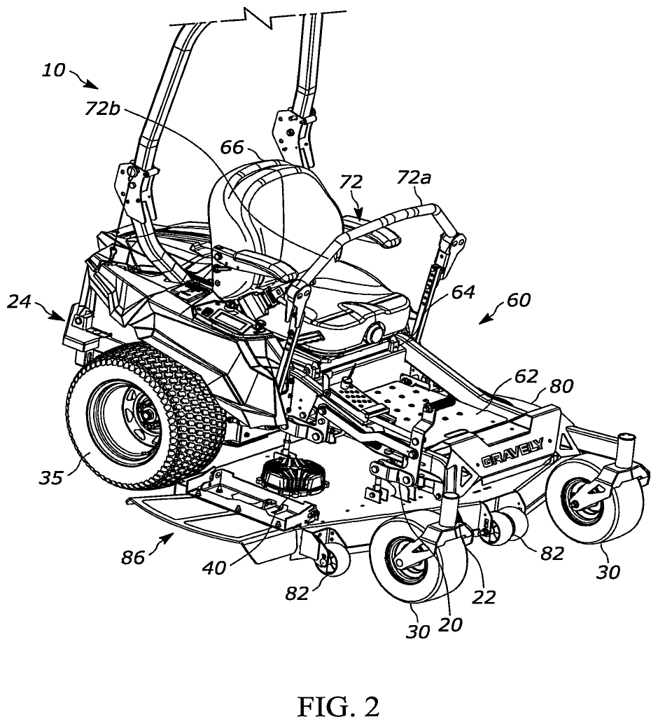

With reference to FIGS. 1 and 2, the operator platform 60 is supported by the frame 20 and straddles the front portion 22 and the rear portion 24 of the frame 20. The illustrated operator platform 60 includes a first or lower section 62 and a second or upper section 64. The lower section 62 is located forward of the upper section 64 and is configured to support a user's feet. The upper section 64 is located rearward of the lower section 62 and supports a seat 66. The seat 66 allows a user to sit during operation of the lawn mower 10 and access the user interface 70. In some embodiments, the operator platform 60 may only include the lower section 62 such that the lawn mower 10 is a standing vehicle. In further embodiments, the operator platform 60 may have other configurations. An operator zone is defined as the seat 66 and all of the controls and other elements of the lawn mower 10 that can be reached by or seen by the user while seated, such as the user interface 70 and the lower section 62.

The user interface 70 (schematically illustrated in FIG. 1) includes maneuvering controls 72 and a system interface 74 supported by the frame 20 within the operator zone. The maneuvering controls 72 are operable to control the lawn mower 10. For example, the maneuvering controls 72 can be used to control the drive motors 45 to drive a desired speed and direction of rotation of the rear ground-engaging elements 35 to move and/or turn the lawn mower 10. In the illustrated embodiment, the maneuvering controls 72 include left and right control arms 72a, 72b used for a zero-turn radius (ZTR) lawn mower. The drive motors 45 are manipulated with the left and right control arms 72a, 72b, with the left control arm 72a controlling the direction and speed of rotation of the left drive wheel 35 and the right control arm 72b controlling the direction and speed of rotation of the right drive wheel 35. In other embodiments, the maneuvering controls 72 may include other suitable actuators, such as a steering wheel, joystick(s), and the like.

The system interface 74 may include an ignition 76, a user display 78, and control switches 79 (e.g., an adjustment switches in the form of dials, push buttons, etc., which will be described in more detail below). The ignition 76 communicates with the vehicle control module 90 to allow the user to selectively provide power to (i.e., activate) the drive motors 45 and the deck motors 40. In some embodiments, ignition 76 includes separate switches that activate the drive motors 45 and the deck motors 40 independently or by group. The user display 78 communicates with the vehicle control module 90 to display information to the user. For example, the user display 78 may display a state of charge of the power source 50, an operational state (e.g., the current operation mode) of the lawn mower 10, etc. In some embodiments, the user display 78 is a touch screen display that may also receive user input and convey the received user input to the vehicle control module 90. The control switches 79 and the user display 78 may interact with the vehicle control module 90 to control functions of the mower 10 (e.g., activation of deck motor 40, drive motors 45, maximum variable speed, etc.).

The vehicle control module 90, which may also be referred to as a vehicle controller, includes an electronic controller having an electronic processor, a memory, and an input/output (I/O) interface. The memory stores instructions that may be retrieved and executed by the electronic processor to execute the functionality of the vehicle control module 90 described herein.

Although not illustrated, in some embodiments, the user interface 70, the system interface 74, the vehicle control module 90, the sensors 110, and other vehicle components and systems are communicatively coupled with a suitable communication bus (e.g., a Controller Area Network (CAN) bus). Control and data messages are exchanged between components of the mower 10 via the communication bus.

With reference to FIG. 3, the cutting deck 80 is supported underneath the frame 20 mainly in the front portion 22 in the illustrated embodiment, but in other embodiments might be moved rearward to the center or even fully to the rear portion 24, for example. The cutting deck 80 includes one or more ground-engaging elements 82 (e.g., anti-scalping rollers) that support the cutting deck 80 on the ground. As illustrated in FIGS. 1 and 2, the deck motors 40 are mounted to the cutting deck 80. In the illustrated embodiment, the cutting deck 80 includes three deck motors 40. In other embodiments, the cutting deck 80 may include fewer deck motors 40 (e.g., one or two) or more deck motors 40 (e.g., three, four, etc.). Referring back to FIG. 3, each deck motor 40 is mounted at least partially above the cutting deck 80 to provide access to cooling ambient air and includes an output shaft under the cutting deck 80. A blade 84 is mounted under the cutting deck 80 to each output shaft and rotates under the influence of the deck motor 40 to cut grass under the cutting deck 80. In the illustrated embodiment, the cutting deck 80 includes a side discharge opening 86 to discharge mown grass. In other embodiments, the cutting deck 80 may include a rear discharge, a collection bag, etc. to collect or discharge mown grass from under the cutting deck 80. In other embodiments, the blades 84 may be configured to mulch the grass clippings in which case there may be no discharge opening 86 or the discharge opening 86 may include a mechanism for opening and closing to selectively provide discharge and mulching functionality. Each of the deck motors 40 directly drives a single blade 84 and can therefore be termed a direct-drive, dedicated deck motor 40.

The vehicle control module 90 interacts with the user interface 70, the drive motors 45, the deck motors 40, and the sensors 110 during operation of the mower 10. More specifically, the vehicle control module 90 may take input from the user interface 70 or the controller 100 and relay instructions to the drive motors 45 and the deck motors 40. The vehicle control module 90 may also receive information from the power source 50, such as state of charge of the batteries and other battery-related information and relay this information to the user interface 70 and the controller 100. The user display 78 and the controller 100 may display information to the user such as state of charge of the power source 50, operation mode of mower 10, etc. While lawn mower 10 is described above as an electric zero turn lawn mower, it should be appreciated that the battery assembly and/or control systems described below may be used with any utility device that is operable to cut grass. Also, in alternative embodiments, the vehicle control module 90 may be implemented on other vehicles or outdoor power equipment, such as snow throwers, utility vehicles, tractors, etc.

With reference to FIG. 1, the mower 10 is operable to be controlled in a normal operation mode, a learning mode, and an autonomous mode. In the normal mode, the vehicle control module 90 receives inputs from an operator via the maneuver controls 72 and the system interface 74. In the learning mode, the mower 10 may be operated by the user or autonomously (e.g., via the controller 100) to learn the boundary of a desired workspace. In the autonomous mode, the mower 10 may operate within the desired workspace without an operator. For example, the operator may activate the autonomous mode of the mower 10, and the mower 10 may autonomously navigate the desired workspace (e.g., until the workspace is mowed or the mower 10 is remotely disabled). In some embodiments, the mower 10 may be controlled remotely by the user via the controller 100. In order to allow the mower 10 to operate in each mode, certain sensors 110 on the mower are disabled or adjusted. In the illustrated embodiment, the user may switch between modes by selecting the mode on the user display 78 of the system interface 74 or on the controller 100. In other embodiments, switching between modes may be accomplished via discrete I/O, the user interface, or the controller 100.

The vehicle control module 90 determines the mode of the mower 10 based on the user selection and communicates the mode via a CAN communication message. In some embodiments, the vehicle control module 90 communicates the mode by broadcasting a digital message. In one example, mode selection by the user is reflected by the controller 100 by applying a voltage (e.g., +5 volts) on one of two analog inputs of a switched battery configuration. The values of these inputs may be used to trigger the digital messages (e.g., 00, 01, 10, or 11), as illustrated in Table 1 below.

TABLE 1
Mode Selection Truth Table

| Mode | Input POS 2 | Input POS 3 |
|---|---|---|
| Mode 0 (Normal) | 0 | 0 |
| Mode 1 (Learning) | 1 | 0 |
| Mode 2 (Autonomous) | 0 | 1 |

As described herein, each of the operation modes of the mower 10 (e.g., operation, learning, autonomous) utilizes a discrete set of operational parameters, which are stored in a memory of the vehicle control module 90. Operational parameters, when applied, may activate or deactivate functions, set range limits, set default values, apply calibrations for sensors, and the like. As set forth below, in response to the selection of an operation mode, the vehicle control module 90 retrieves from its memory and applies the associated set of operational parameters to define and regulate control of the mower 10. In some embodiments, each set of operational parameters is unique.

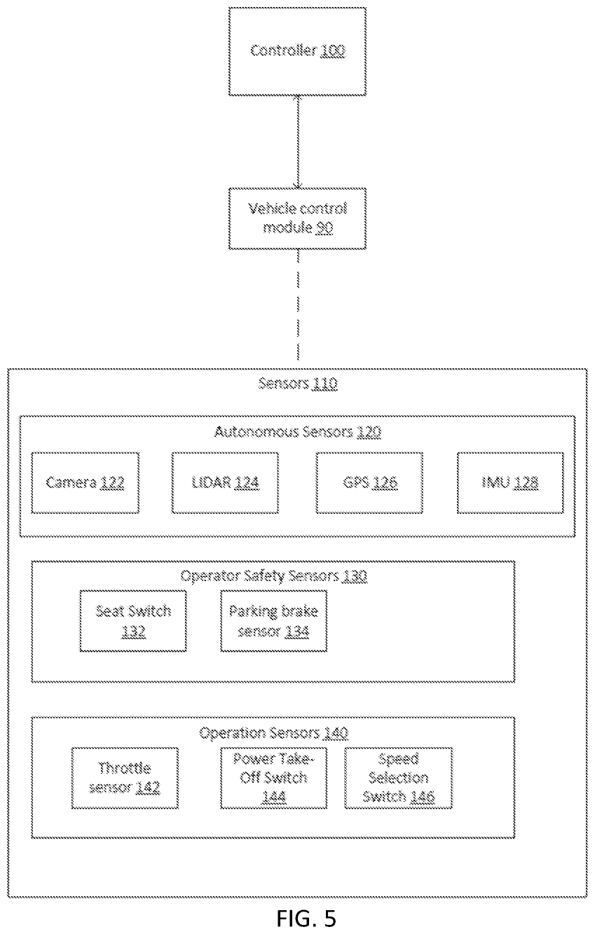

Now with reference to FIG. 5, the sensors 110 of the mower 10 are illustrated. The sensors 110 include autonomous sensors 120, operator safety sensors 130, and operation sensors 140. The autonomous sensors 120 may include one or more cameras 122 (e.g., a global shutter stereo camera), a light detection and range module (LIDAR) 124, a global positioning system (GPS) 126, and an inertial measurement unit (IMU) 128. For example, the mower 10 may include four global shutter stereo cameras (front, rear, right, left) that simultaneously capture images of the workspace surrounding the mower 10. The vehicle control module 90 may communicate with the cameras 122 and use the generated image data to implement computer vision for localization and navigation within the desired workspace. In some embodiments, the LIDAR, the GPS, and the IMU are not used for localization or navigation. Rather, the LIDAR, GPS and IMU may be used for various other features such as tracking the mower 10, detecting objects in the desired path, determining the orientation of the mower (e.g., on an incline, etc.), and the like.

The operator safety sensors 130 may include a seat switch 132 that detects the presence of an operator on the seat 66 and a parking brake sensor 134 that detects the position of a parking brake (not shown) as being either in an enabled position (that restricts movement of the mower 10) or a disabled position (in which movement of the mower 10 is not restricted by the brake). The seat switch 132 and parking brake sensor 134 may each be binary electro-mechanical switches that, when actuated (e.g., by the force of a person sitting on the seat 66 or a parking brake handle being actuated into an enabled position), close an electrical contact to provide a signal to the vehicle control module 90 indicating the seat and parking brake status, respectively. In some embodiments, other sensors are used (e.g., Hall sensors, capacitive sensors, or potentiometers) to implement the seat switch 132, the parking brake sensor 134, or both.

The operation sensors 140 include a throttle sensor 142 in communication with the maneuver controls 72 to selectively control the prime movers 45, a power take-off switch 144 in communication with the deck motors 40 to selectively provide power to the deck motors 40, and a speed selection switch 146 that selectively reduces the maximum speed of the prime movers 45. The throttle sensor 142 may include a pair of sensors, one for each of the left and right control arms 72a and 72b, where each sensor is configured to output a signal to the vehicle control module 90 proportional to the position or angle of the left and right control arms 72a and 72b. The throttle sensor 142 may be, for example, a non-contact rotary encoder, a potentiometer, or a Hall sensor that is located near or at the axis of rotation of each of the maneuver controls 72. The power take-off switch 144 may be an electro-mechanical switch operated by a user (e.g., a foot pedal, pushbutton, or lever) that outputs a signal to the vehicle control module 90 indicating whether it is enabled or disabled. Similarly, the speed selection switch 146 may be an electro-mechanical switch operated by a user (e.g., a foot pedal, pushbutton, or lever) that outputs a signal to the vehicle control module 90 indicating whether it is enabled or disabled.

In some embodiments, to start the mower 10 or switch between different operation modes, the parking brake must be engaged (as indicated by the parking brake sensor 134) and the operator must be seated (as indicated by the seat switch 132). In normal operation mode, the vehicle control module 90 of the mower 10 receives inputs from the maneuver controls 72 and the system interface 74 to control the operation of the prime movers 45 and the deck motors 40.

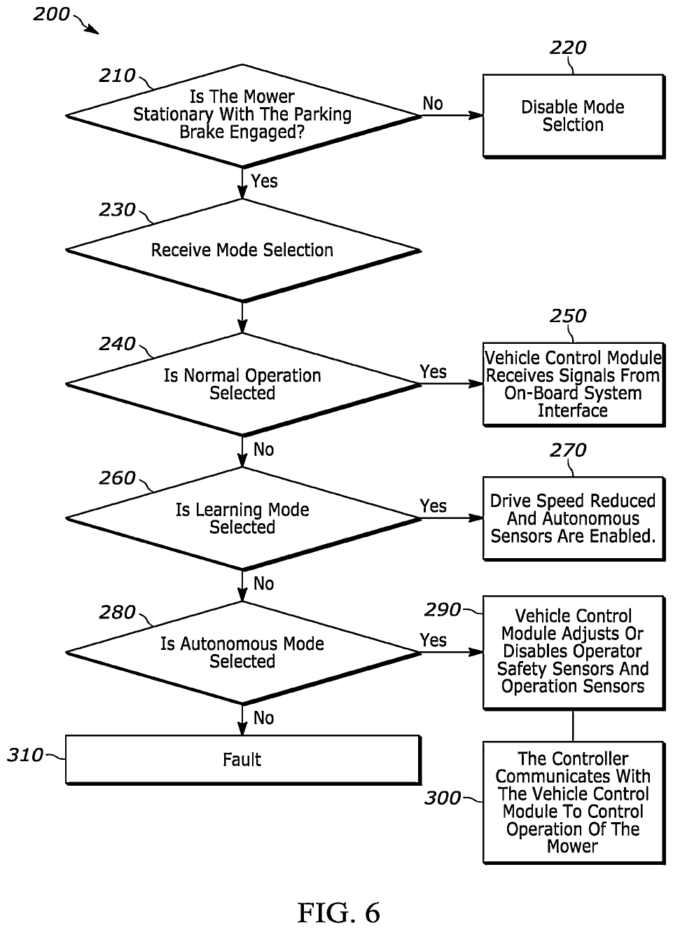

Now with reference to FIG. 6, control logic 200 of the vehicle control module 90 is illustrated. The vehicle control module 90 determines if the mower 10 is stationary and the parking brake is engaged (Step 210). For example, the vehicle control module 90 receives a signal from the parking brake sensor 134 indicative of whether the parking brake is engaged, and from the IMU 128 indicative of whether the mower 10 is moving. When the mower is not stationary, does not have the parking brake enabled, or both, the vehicle control module 90 disables the mode selection (Step 220). When mode selection is disabled, the vehicle control module 90 will ignore user mode selection inputs that it may receive. In some embodiments, an additional condition in Step 210 is whether the operator is seated (as indicated by the seat switch 132). In such embodiments, when any of the mower 10 not being stationary, the mower 10 not having the parking brake enabled, or the operator not being seated is true, the vehicle control module 90 disables the mode selection (Step 220). If the vehicle control module 90 determines that the mower 10 is stationary and the parking brake is engaged (and, in some embodiments, that the operator is seated), the vehicle control module 90 allows the operator to select between the normal mode, the learning mode, and the autonomous mode. In other words, the vehicle control module 90 receives a mode selection (Step 230). The vehicle control module 90 receives a mode selection, for example, in response to user actuation of a mode selector push button (e.g., where each actuation is a request to proceed to the next mode so that the modes may be cycled through) or user selection of a soft key on a touch screen (e.g., a soft key button may be provided for each mode and displayed on the user display 78 for selection by user touch). In some embodiments, mode selection performed with a discrete input to the vehicle control module 90, which goes high for mode selection. For example, the mower 10 may include an electromechanical switch wired to a software configured input of the vehicle control module 90 that when switched high would transition modes based on which input was high (e.g., as described herein with respect to Table 1).

In Step 240, the vehicle control module 90 determines whether the normal mode is selected based on the received mode selection. If so, the vehicle control module 90 receives signals from the on-board system interface 74 and the maneuver controls 72, and controls the mower 10 according to those received signals (Step 250). As noted, each operation mode is defined in part by operational parameters (as described herein) for each of the mower 10. The parameters are stored in a memory of the vehicle control module 90. In some embodiments, in response to the selection of an operation mode (e.g., as described above with respect to Steps 210, 220, and 230), the vehicle control module 90 retrieves from the memory the set of parameters associated with the selected operation mode and applies the parameters to the systems and components of the mower 10.

For example, non-linear control systems are more intuitive for a human operator than linear control systems. Accordingly, the parameters for the normal operation mode, when applied, activate control algorithms that provide for nonlinear responses to operator inputs during the operation of the mower 10. In some embodiments, the control algorithms include a proportional integral (PI) control loop and a variable speed control system, both of which are described more fully in International Publication Number WO 2021/071655 A1 (entitled “Power Source and Control System for a Lawn Mower”). The vehicle control module 90 executes such algorithms to control the operation of the mower 10.

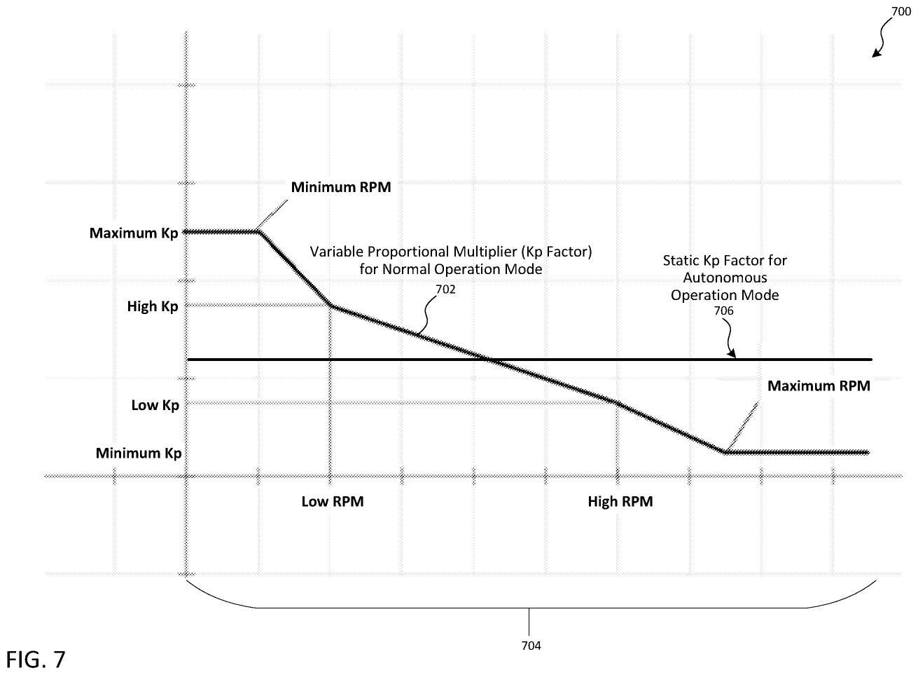

As illustrated in the control graph 700 of FIG. 7, the PI control loop utilizes a variable proportional multiplier 702 (Kp-Factor) based on motor RPM to adjust the systems control loop to create the desired responsiveness at any motor RPM. The variable proportional multiplier 702 is adjusted to provide optimal drivability over the entire operating range 704. The example control graph 700 demonstrates how the functional Kp value is adjusted based on motor RPM. Kp values are higher at low motor RPM, thereby increasing stick responsiveness to operator input. Similarly, at higher motor RPM, Kp values are reduced to provide the operator with a smooth and controllable drive at high speeds. In some embodiments, when the normal operation mode is selected, the parameters for the normal operation mode provide a variable Kp factor as described above.

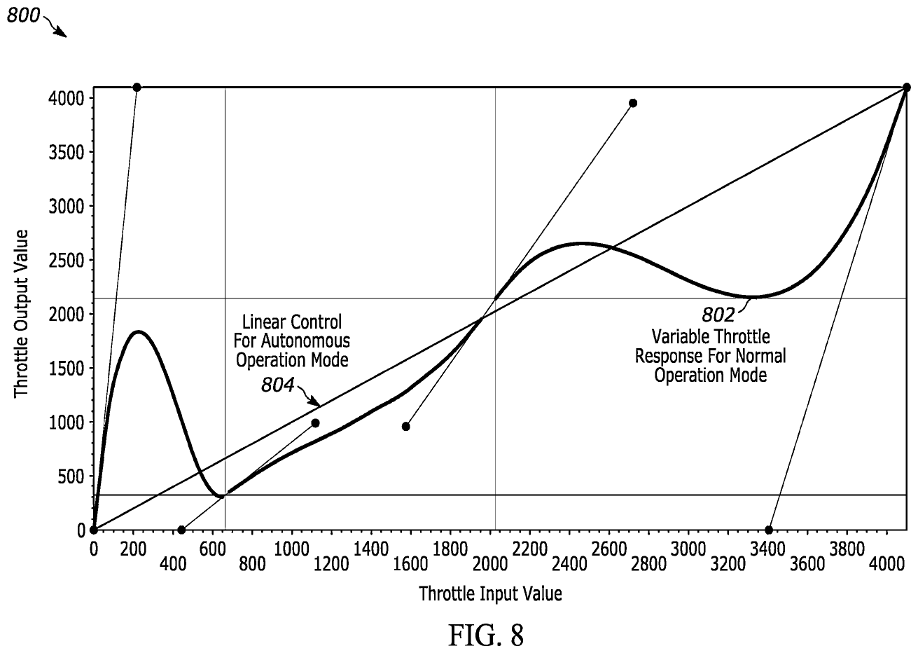

In an effort to keep movement of the maneuvering controls (e.g., the left and right control arms 72a, 72b) similar at any operational speed range, the variable speed control system provides a continuously variable input speed compensation factor. As illustrated in the chart 800 of FIG. 8, the input speed compensation factor allows for maximum stick movement at lower speeds. One example embodiment of a variable input speed compensation factor is represented by the Bezier curve 802. During normal operation, the positions of the left and right control arms 72a, 72b are still covering the maximum range (i.e., the steering sensors read from −100% to 100% and transmit this data to the vehicle control module 90). However, as illustrated in FIG. 8, applying the Bezier curve 802 to throttle input values to determine adjusted throttle output values results in a variable throttle response, making the throttle acceleration feel smoother for the human operator throughout the operational range.

If the normal operation mode was not selected, the vehicle control module 90 determines whether the learning operation mode is selected (Step 260). If so, the vehicle control module 90 loads the parameters for the learning mode, which when applied, among other things, reduce the maximum drive speed of the drive motors 45 and enable the autonomous sensors 120 (Step 270). The maximum drive speed is reduced by a parameter which caps the top RPM of the drive motors 45 (for example, by setting a maximum RPM value for the drive motors 45, the maximum RPM value being the highest RPM at which the drive motors 45 operate regardless of the speed called for by an operator). An operator is still able to request (e.g., with the maneuver controls 72) full throttle, however that request for 100% throttle will result in a lower speed than it would in normal operation mode.

In the learning operation mode, the operator operates the mower 10. Accordingly, the operational parameters for the learning mode include activating the variable proportional multiplier and the variable input speed compensation factor to improve drivability for the human operator, just as in the normal mode. The vehicle control module 90 receives signals from the on-board system interface 74 and the maneuver controls 72 and controls the mower 10 according to those received signals (except with the reduced maximum speed and with the autonomous sensors 120 enabled). In the learning mode, the operator may drive the mower 10 around a boundary of a desired workspace (e.g., an area to be mowed). The one or more cameras 122 communicate with the vehicle control module 90, which uses computer vision to determine the boundary of the workspace. For example, the vehicle control module 90 may process and store image data received from the cameras 122 as the mower 10 moves along the boundary. This stored image data may later be compared to new image data from the camera(s) 122 (e.g., during autonomous mowing operation) to identify matching image data and, thereby, recognize boundaries. Once the operator drives around the boundary, the operator may input a stop command (e.g., via the system interface 74 or the controller 100) to instruct the vehicle control module 90 that the boundary is learned. In some embodiments, if the operator changes the operation mode back to normal mode or to the autonomous mode, the vehicle control module may determine the boundary is learned. By reducing the maximum drive speed, the one or more cameras 122 are provided additional time to capture images, the vehicle control module 90 is provided additional time to process and store image data received from the one or more cameras 122, and the user may be able to control the mower 10 with finer precision.

If the normal operation mode or learning operation mode was not selected, the vehicle control module 90 determines whether the autonomous mode is selected (Step 280). If so, the vehicle control module 90 loads the parameters for the autonomous mode, which when applied, among other things, adjust or disable one or more of the operator safety sensors 130 and operation sensors 140 (Step 290). For example, the vehicle control module 90 may disable the seat switch 132 (e.g., so the operator does not need to be seated for the mower 10 to operate), adjust the maximum speed of the mower 10, and change the input source for mower control to the operation sensors 140. In another example, the controller 100 may be configured to communicate with the vehicle control module 90 to adjust parameters such as the speed of the mower 10, the power to the deck motors, etc., regardless of the position of the power take-off switch 144, a speed selection switch 146, etc. As a result, the controller 100 communicates with the vehicle control module 90 to control operation of the mower 10. In some embodiments, these parameters may also be stored in the memory of the vehicle control module 90 and loaded upon selection of the autonomous operation mode, in which the vehicle control module 90 autonomously operates the mower 10.

The variable proportional multiplier and the variable input speed compensation factor, which provide non-linear controls for a human operator, are unnecessary when the mower is under autonomous control. Linear control of the drive and steering of the mower 10 provides for improved operation while under autonomous control. Accordingly, in some embodiments, the operational parameters for the autonomous operation mode provide for linear control of the mower 10. For example, as illustrated in FIG. 7, the vehicle control module 90 applies to the PI control loop a continuous Kp factor 706 over the entire operating range of the drive motors 45. In another example, as illustrated in FIG. 8, rather than following the Bezier curve 802 for variable throttle response, the vehicle control module 90 applies a linear throttle response (represented by the line 804).

In the autonomous operation mode, in Step 300, the mower 10 is able to travel within the desired workspace and mow the workspace without an operator. The vehicle control module 90 is configured to receive image data from the one or more cameras and process to image data to detect boundaries (learned in the learning mode), detect static objects (e.g., trees, bushes, etc.), dynamic objects (e.g., humans, pets, etc.). In response to detecting a boundary, the vehicle control module 90 may control the mower 10 to turn and stay within the boundaries defined in the learning mode. In response to detecting static objects, the vehicle control module 90 may control the mower 10 to mow around the static objects. In response to detected dynamic objects, the vehicle control module 90 may stop the mower 10 temporarily, and then automatically (without human intervention) restart the mower 10 when the dynamic objects move from the path of the mower 10.

Lastly, in response to an unknown operation mode selection input or otherwise failing to detect that the mower 10 is in the normal operation mode, learning mode, or autonomous mode, the vehicle control module 90 may determine a fault in the mower 10. For example, a fault may occur if there is a hardware issue on the mower 10.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way but may also be configured in ways that are not listed.

Thus, embodiments described herein provide, among other things, systems, methods, and devices related to the control of autonomous electric vehicles. Various features, advantages, and embodiments are set forth in the following claims.

What is claimed is:

1. A utility vehicle comprising:
a frame;
a drive wheel supporting the frame above a ground surface;
a drive motor mounted to the frame and driving rotation of the drive wheel to move the utility vehicle over the ground surface;
a utility device coupled to the frame;
a power source supported by the frame;
a user interface; and
a vehicle control module including a memory, the vehicle control module in communication with the drive motor, the utility device, the power source, and the user interface, the vehicle control module configured to:
receive, from the user interface, a user input selecting an operation mode;
responsive to receiving the user input, retrieve, from the memory, a discrete operational parameter set associated with the operation mode;
apply the discrete operational parameter set; and
operate the drive motor, the drive wheel, the utility device, the power source, and the user interface according to the discrete operational parameter set.

2. The utility vehicle of claim 1, further comprising:
a communication bus communicatively coupled with the drive motor, the utility device, the power source, and the user interface,
wherein the vehicle control module is further configured to, responsive to receiving the user input, broadcast a message on the communication bus, the message identifying the operation mode.

3. The utility vehicle of claim 1,
wherein the operation mode is one selected from the group consisting of a normal operation mode, a learning operation mode, and an autonomous operation mode, each associated with one of a plurality of discrete operational parameter sets stored in the memory.

4. The utility vehicle of claim 3, wherein the one of the plurality of discrete operational parameter sets associated with the normal operation mode includes at least one selected from the group consisting of activating a variable proportional multiplier for a PI control loop and activating a variable input speed compensation factor for a speed control system.

5. The utility vehicle of claim 3, further comprising:
a plurality of autonomous sensors in communication with the vehicle control module;
wherein the one of the plurality of discrete operational parameter sets associated with the learning operation mode includes activating a variable proportional multiplier for a PI control loop, activating a variable input speed compensation factor for a speed control system, activating the autonomous sensors, and reducing a maximum drive speed for the utility vehicle.

6. The utility vehicle of claim 5, wherein reducing a maximum drive speed for the utility vehicle includes setting a maximum RPM value for the drive motor.

7. The utility vehicle of claim 5, wherein the vehicle control module is further configured to:
determine, based on data received from the plurality of autonomous sensors, a boundary
receive, from the user interface, a second user input selecting one of the normal operation mode and the autonomous operation mode; and
responsive to receiving the second user input, store, in the memory, the boundary.

8. The utility vehicle of claim 3, wherein the one of the plurality of discrete operational parameter sets associated with the autonomous operation mode includes deactivating a variable proportional multiplier for a PI control loop and deactivating a variable input speed compensation factor for a speed control system.

9. The utility vehicle of claim 3, further comprising:
an operator safety sensor in communication with the vehicle control module;
a power take-off switch in communication with the vehicle control module and operable to regulate operation of the utility device; and
a speed selection switch in communication with the vehicle control module and operable to regulate the speed of the utility vehicle;
wherein the one of the plurality of discrete operational parameter sets associated with the learning operation mode includes at least one selected from the group consisting of operating the utility vehicle regardless of the status of the operator safety sensor, operating the utility vehicle regardless of the position of the power take-off switch, and operating the utility vehicle regardless of the position of the speed selection switch.

10. The utility vehicle of claim 1, wherein the vehicle control module is further configured to, responsive to one of the user input selecting an unknown operation mode or failing to detect a current operation mode for the utility vehicle, determine a fault.

11. A method for operating a utility vehicle, the method comprising:
receiving, by an electronic controller from a user interface, a user input selecting an operation mode;
responsive to receiving the user input, retrieving, from a memory coupled to the electronic controller, a discrete operational parameter set associated with the operation mode;
applying the discrete operational parameter set; and
operating a drive motor of the utility vehicle, a drive wheel of the utility vehicle, a utility device of the utility vehicle, a power source of the utility vehicle, and the user interface according to the discrete operational parameter set.

12. The method of claim 11, further comprising:
responsive to receiving the user input, broadcasting by the electronic controller of a message on a communication bus, the message identifying the operation mode.

13. The method of claim 11, wherein receiving a user input selecting an operation mode includes receiving a user input identifying one selected from the group consisting of a normal operation mode, a learning operation mode, and an autonomous operation mode, each associated with one of a plurality of discrete operational parameter sets stored in the memory.

14. The method of claim 13, wherein the one of the plurality of discrete operational parameter sets associated with the normal operation mode includes at least one selected from the group consisting of activating a variable proportional multiplier for a PI control loop and activating a variable input speed compensation factor for a speed control system.

15. The method of claim 13, wherein the one of the plurality of discrete operational parameter sets associated with the learning operation mode includes activating a variable proportional multiplier for a PI control loop, activating a variable input speed compensation factor for a speed control system, activating a plurality of autonomous sensors in communication with the vehicle control module, and reducing a maximum drive speed for the utility vehicle.

16. The method of claim 15, wherein reducing a maximum drive speed for the utility vehicle includes setting a maximum RPM value for the drive motor.

17. The method of claim 15, further comprising:
determining, based on data received from the plurality of autonomous sensors, a boundary
receiving, from the user interface, a second user input selecting one of the normal operation mode and the autonomous operation mode; and
responsive to receiving the second user input, storing, in the memory, the boundary.

18. The method of claim 13, wherein the one of the plurality of discrete operational parameter sets associated with the autonomous operation mode includes deactivating a variable proportional multiplier for a PI control loop and deactivating a variable input speed compensation factor for a speed control system.

19. The method of claim 13, wherein the one of the plurality of discrete operational parameter sets associated with the learning operation mode includes at least one selected from the group consisting of operating the utility vehicle regardless of the status of an operator safety sensor, operating the utility vehicle regardless of the position of a power take-off switch operable to regulate operation of the utility device, and operating the utility vehicle regardless of the position of a speed selection switch operable to regulate the speed of the utility vehicle.

20. The method of claim 13, further comprising:
responsive to one of the user input selecting an unknown operation mode or failing to detect a current operation mode for the utility vehicle, determining a fault.
